(19) United States
(12) Patent Application Publication
(10) Pub. No.: US 2026/0044721 A1
(43) Pub. Date: Feb. 12, 2026

(54) ELECTRONIC DEVICE AND METHOD WITH TRANSFORMER FINE TUNING

(71) Applicants: Samsung Electronics Co., Ltd., Suwon-si (KR); IUCF-HYU (Industry-University Cooperation Foundation Hanyang University), Seoul (KR)

(72) Inventors: Jungwook CHOI, Seoul (KR); Minsoo KIM, Seoul (KR)

(73) Assignees: Samsung Electronics Co., Ltd., Suwon-si (KR); IUCF-HYU (Industry-University Cooperation Foundation Hanyang University), Seoul (KR)

(21) Appl. No.: 19/294,849

(22) Filed: Aug. 8, 2025

(30) Foreign Application Priority Data
Aug. 8, 2024 (KR) 10-2024-0106215
Sep. 26, 2024 (KR) 10-2024-0130865

(51) Int. Cl. G06N 3/0495; G06N 3/082

(52) U.S. Cl. CPC G06N 3/0495; G06N 3/082

(57) ABSTRACT

A processor-implemented method includes determining a quantization error matrix by applying quantization to weight matrices of sublayers included in each of layers of a transformer comprising an adapter layer, determining ranks of adapter weight matrices of sublayers included in one of the layers based on singular value decomposition (SVD) for the quantization error matrix, and fine-tuning the transformer based on the ranks of the adapter weight matrices.

### CROSS-REFERENCE TO RELATED APPLICATIONS

This application claims the benefit under 35 USC § 119 (a) of Korean Patent Application No. 10-2024-0106215, filed on Aug. 8, 2024, and Korean Patent Application No. 10-2024-0130865, filed on Sep. 26, 2024, in the Korean Intellectual Property Office, the entire disclosures of which are incorporated herein by reference for all purposes.

### BACKGROUND

### 1. Field

The following examples relate to an electronic device and method with transformer fine-tuning.

### 2. Description of Related Art

A neural network model, such as a large language model (LLM), may be pre-trained with a large amount of pre-collected training data and then fine-tuned with training data that is appropriate for a predetermined task to be performed. When the size of the neural network model is large, the computational resources and/or memory resources required to perform fine-tuning may increase significantly. In addition, fine-tuning at low precision may lead to a decrease in the accuracy of inference results of the neural network model.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method includes determining a quantization error matrix by applying quantization to weight matrices of sublayers included in each of layers of a transformer comprising an adapter layer, determining ranks of adapter weight matrices of sublayers included in one of the layers based on singular value decomposition (SVD) for the quantization error matrix, and fine-tuning the transformer based on the ranks of the adapter weight matrices.

The determining of the quantization error matrix may include applying low-precision quantization to the weight matrices of the sublayers, and determining the quantization error matrix based on differences between the matrices to which the low-precision quantization is applied and the weight matrices.

The determining of the ranks of the adapter weight matrices may include decomposing the quantization error matrix into a singular value and a singular vector by applying SVD to the quantization error matrix, and determining the ranks of the adapter weight matrices of the sublayers based on the singular value.

The determining of the ranks of the adapter weight matrices of the sublayers may include determining normalized cumulative singular values (NCSVs) of the sublayers based on the singular value, and determining the ranks of the adapter weight matrices of the sublayers by comparing the NCSVs of the sublayers.

The determining of the ranks of the adapter weight matrices of the sublayers may include sorting the NCSVs of the sublayers in descending order, and determining the ranks of the adapter weight matrices of the sublayers based on indices of the sublayers sorted in descending order.

The fine-tuning of the transformer may include initializing the adapter weight matrices of the sublayers, and fine-tuning the transformer by setting the initialized adapter weight matrices as training parameters.

The initializing of the adapter weight matrices of the sublayers may include initializing the adapter weight matrices of the sublayers by an approximated quantization error based on the ranks of the weight matrices.

The sublayers may include a query vector, a key vector, a value vector, an output projection vector, and a hyperparameter of one or more fully connected layers.

The transformer may be included in one of an encoder-only model and a large language model (LLM).

In one or more general aspects, a non-transitory computer-readable storage medium may store instructions that, when executed by one or more processors, configure the one or more processors to perform any one, any combination, or all of operations and/or methods disclosed herein.

In one or more general aspects, a processor-implemented method includes applying low-precision quantization to weight matrices of sublayers of a layer of a transformer-based neural network model, determining a quantization error matrix based on differences between the matrices to which the low-precision quantization is applied and the weight matrices, decomposing the quantization error matrix into a singular value and a singular vector by applying singular value decomposition (SVD), determining normalized cumulative singular values (NCSVs) of the sublayers based on the singular value, determining ranks of adapter weight matrices of sublayers included in one layer by comparing the NCSVs of the sublayers, initializing the adapter weight matrices of the sublayers by an approximated quantization error based on the determined ranks, and performing fine-tuning by setting the initialized adapter weight matrices as training parameters.

In one or more general aspects, an electronic device includes one or more processors configured to determine a quantization error matrix by applying quantization to weight matrices of sublayers included in each of layers of a transformer comprising an adapter layer, determine ranks of adapter weight matrices of sublayers included in one of the layers based on singular value decomposition (SVD) for the quantization error matrix, and fine-tune the transformer based on the determined ranks of the adapter weight matrices.

For the determining of the quantization error matrix, the one or more processors may be configured to apply low-precision quantization to the weight matrices of the sublayers, and determine the quantization error matrix based on differences between the matrices to which the low-precision quantization is applied and the weight matrices.

For the determining of the ranks of the adapter weight matrices, the one or more processors may be configured to decompose the quantization error matrix into a singular value and a singular vector by applying SVD to the quantization error matrix, and determine the ranks of the adapter weight matrices of the sublayers based on the singular value.

For the determining of the ranks of the adapter weight matrices of the sublayers, the one or more processors may be configured to determine normalized cumulative singular values (NCSVs) of the sublayers based on the singular value, and determine the ranks of the adapter weight matrices of the sublayers by comparing the NCSVs of the sublayers.

For the determining of the ranks of the adapter weight matrices of the sublayers, the one or more processors may be configured to sort the NCSVs of the sublayers in descending order, and determine the ranks of the adapter weight matrices of the sublayers based on indices of the sublayers sorted in descending order.

For the fine-tuning of the transformer, the one or more processors may be configured to initialize the adapter weight matrices of the sublayers, and fine-tune the transformer by setting the initialized adapter weight matrices as training parameters.

For the initializing of the adapter weight matrices of the sublayers, the one or more processors may be configured to initialize the adapter weight matrices of the sublayers by an approximated quantization error based on the determined ranks of the weight matrices.

The sublayers may include a query vector, a key vector, a value vector, an output projection vector, and a hyperparameter of one or more fully connected layers.

The transformer may be included in one of an encoder-only model and a large language model (LLM).

Other features and aspects will be apparent from the following detailed description, the drawings, and the claims.

### BRIEF DESCRIPTION OF THE DRAWINGS

FIG. 1 illustrates an example of a structure and operation of a transformer.

FIG. 2 illustrates an example of pre-training and fine-tuning of a transformer.

FIG. 3 illustrates an example of adapter weights used in fine-tuning.

FIG. 4 illustrates an example of a method of fine-tuning a transformer.

FIG. 5 illustrates an example of determining a quantization error matrix.

FIG. 6 illustrates an example of determining ranks of adapter weight matrices.

FIG. 7 illustrates an example of fine-tuning a transformer.

FIG. 8 illustrates an example of a method of fine-tuning a transformer.

FIG. 9 illustrates an example of an electronic device.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

Although terms such as “first,” “second,” and “third,” or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but is used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on,” “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” to specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art, and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment,” and “one or more examples” has a same meaning as “in one or more embodiments”).

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Hereinafter, examples will be described in detail with reference to the accompanying drawings. When describing the examples with reference to the accompanying drawings, like reference numerals refer to like components, and any repeated description related thereto will be omitted.

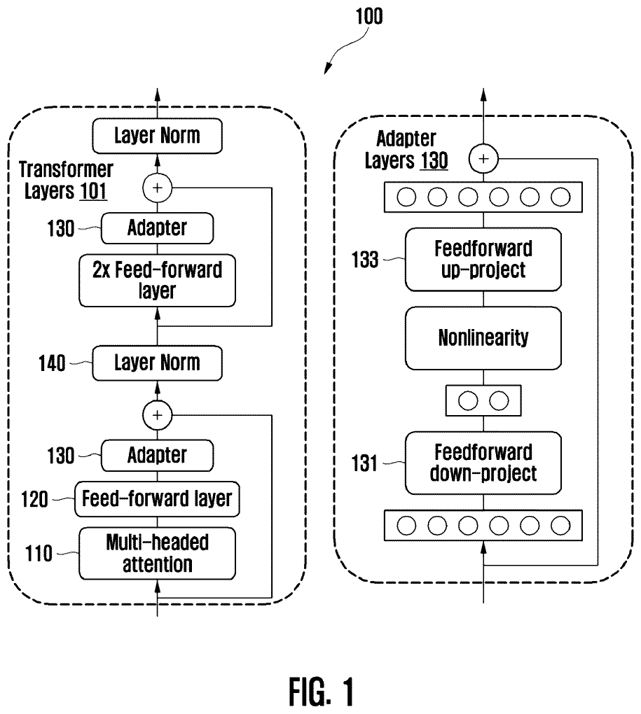

FIG. 1 illustrates an example of a structure and operation of a transformer. Referring to FIG. 1, a transformer (e.g., a transformer model) 100 according to an example may include transformer layers 101 including sublayers such as an attention layer 110, a feedforward layer 120, adapter layers 130, and a layer normalization layer 140.

The transformer 100 may have an encoder-decoder structure in which an encoder receives an input sequence and a decoder outputs an output sequence. The transformer 100 may perform, for example, positional encoding that adds pieces of position information to an embedding vector of each word and uses the same as input of a model, to obtain position information of a word. When positional encoding is performed, ordering information may be preserved. By adding the value of positional encoding to each embedding vector, the value of the embedding vector input to the transformer 100 may vary depending on the position of a word in a sentence, even for the same word. Accordingly, the input of the transformer 100 may be an embedding vector with ordering information considered.

The attention layer 110 may be, for example, a multi-headed attention layer, but is not necessarily limited thereto. The multi-headed attention layer may learn a variety of information by dividing a self-attention operation into multiple heads and performing the self-attention operation in parallel, thereby learning data in many aspects, such as grammatical and semantic relationships.

The attention layer 110 may perform a self-attention operation as follows.

The attention layer 110 may perform input embedding to convert each input word into a vector with a fixed size, such that each input vector may be converted into a query vector Q, a key vector K, and a value vector V. The attention layer 110 may change a vector with d dimensions into a query vector Q, a key vector K, and a value vector V, and perform an attentional function. The attention layer 110 may determine an attention score. The attentional layer 110 may determine an attentional score between each pair of words through the dot product of a query vector Q and a key vector K. The attention layer 110 may convert the attention score into a probability distribution by applying softmax to the attention score. The attention layer 110 may obtain a weighted sum by multiplying each value vector V by a softmax probability.

As described above, the attention layer 110 may perform an attention operation for a given query to obtain the similarities to all keys. The attention layer 110 may reflect the obtained similarities as weights to the respective values mapped to the keys. The attention layer 110 may output a weighted sum of all the values reflecting the similarities. Here, a query may refer to hidden states in a decoder cell at all points in time. A key may refer to hidden states of an encoder cell at all points in time. A value may refer to hidden states of an encoder cell at all points in time.

The feedforward layer 120 may include two dense layers (e.g., a first dense layer and a second dense layer) that are applied independently to a vector at each position. The two dense layers may increase the expressiveness of a neural network model principally by performing nonlinear transformation.

An example of the operation process of the feedforward layer 120 may be as follows.

The feedforward layer 120 may perform linear transformation on an input vector through the first dense layer. The feedforward layer 120 may apply a nonlinear activation function, such as ReLU, to the linear transformation result and then perform linear transformation once again. This process may be performed independently at each position of the transformer 100, and thus the neural network model may learn complex patterns of input data.

In response to performing the respective operations of the attention layer 110 and the feedforward layer 120 in the transformer 100, projection may be performed. The purpose of projection is to convert the output of sublayers to a size equal to the input size of a corresponding layer of the transformer 100. The adapter layer 130 may have a bottleneck structure to limit the number of parameters. The adapter layer 130 may nonlinearly apply and project the original d dimensions into m dimensions and then back into d dimensions. In this case, the total number of parameters added per layer may be 2md+d+m.

The adapter layer 130 may include a feedforward down-projection layer 131 and a feedforward up-projection layer 133.

The feedforward down-projection layer 131 may generate m-dimensional output features for d-dimensional input features by performing projection from d dimensions to m dimensions. The number of parameters may be dm, and m biases may be added. The feedforward up-projection layer 133 may generate d-dimensional output features for m-dimensional input features by performing projection from m dimensions to d dimensions. The number of parameters may be md, and d biases may be added. Here, m<<d, and as m decreases, the size of all parameters may also decrease.

As described above, the adapter layer 130 may project the output of the feedforward layer 120 back to the input size and then apply the projection result to the output of the sublayers before adding skip connection. Skip connection is a technique used in deep learning models, and may be a method of transmitting the output of a predetermined layer directly to a subsequent layer. Skip connection may be used principally in a residual network (ResNet) and may mitigate the issue of vanishing gradient that occurs in deep neural networks, thereby enabling smoother learning. Also, skip connection may also transmit input data directly, not through multiple layers of the network, ensuring that important information may be transmitted to a sublayer without loss. Skip connection may be implemented principally by concatenation with addition ⊕. Addition may be a method of adding two feature maps pixelwise, and concatenation may be a method of joining two feature maps channelwise. Skip connection may correspond to a path directly connected by without ⊕ the process from the input of the attentional layer 110 to the output of the adapter layer 130.

The result of the adapter layer 130 may be input to the layer normalization layer 140, which performs normalization for layers.

The layer normalization layer 140 may obtain the mean and variance of the last dimension of the summation result between the output of the adapter layer 130 and skip connection, and normalize and use the same to train the transformer 100.

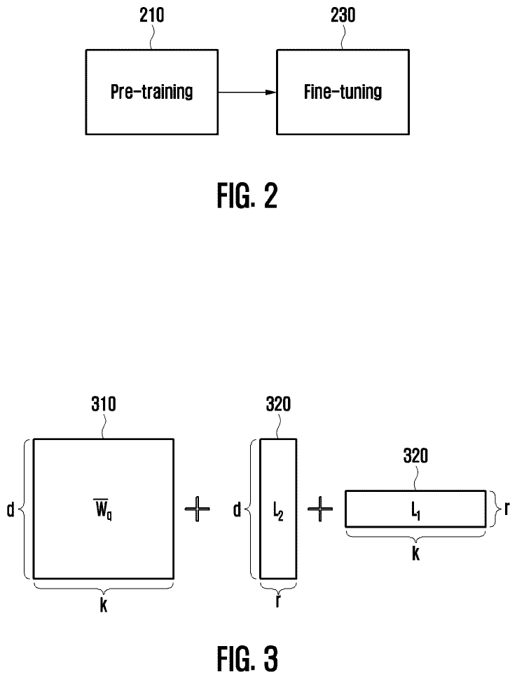

FIG. 2 illustrates an example of pre-training and fine-tuning of a transformer. Referring to FIG. 2, a process of training a neural network model (e.g., a transformer) according to an example may be divided into pre-training 210 and fine-tuning 230.

The neural network model may be a neural network including a plurality of layers. In an example, the neural network may include an input layer, a plurality of hidden layers, and an output layer. Each of the layers may include a plurality of nodes. Each node determine may generate an output by performing an operation on one or more inputs, and the nodes may be connected to each other. A weight may be set for a connection between nodes, and the weight may be adjusted or changed. The weight may amplify, reduce, or maintain a relevant data value, thereby determining the degree of influence of the data value on a final result. Weighted inputs of nodes included in a previous layer may be input into each node included in the output layer. A process of inputting weighted data from a predetermined layer to the next layer may be referred to as propagation.

The neural network model may include, for example, a large language model (LLM), a transformer, a transformer-based vision transformer, an encoder-only model, and/or a multi-modal model, but is not necessarily limited thereto.

Pre-training 210 of the neural network model may refer to training the neural network model with a large dataset or a dataset suitable for a predetermined task. While pre-training 210 is being performed, the parameters (e.g., weights) of the neural network model may be adjusted or changed.

Fine-tuning 230 may refer to additional training of the entirety or a portion of the neural network model trained through pre-training 210 to be suitable for a new task. The parameters of the pre-trained neural network model may be adjusted to be suitable for a new dataset (e.g., to generate accurate outputs for the new task), and the overall structure of the neural network model may be fine-tuned accordingly. Fine-tuning 230 may be used to maximize performance for a new task based on the knowledge that the neural network model already has. Fine-tuning 230 may be useful for a task with a small dataset.

Parameter-efficient fine-tuning (PEFT) of the neural network model may refer to fine-tuning some parameters of the pre-trained neural network model based on a new task, rather than training a new (e.g., untrained) neural network model from the beginning for the new task.

Fine-tuning 230 may be performed based on the weights determined in pre-training 210 as well as final weights determined by further consideration of additional weights. Herein, for ease of description, the weights determined in pre-training 210 may be referred to as the “base weights”, and the additional weights considered in fine-tuning 230 may be referred to as the “adapter weights”.

For example, a quantization-based PEFT technique of a large language model (LLM) may contribute to a significant reduction of the amount of memory required for fine-tuning 230 through quantization of weight matrices of the LLM, but may have a serious accuracy degradation at low precision (e.g., 2-bit low precision). To address the accuracy degradation at low precision, quantization errors may be approximated to initialize the adapter weights of the PEFT technique, but the accuracy degradation may still be significant at 2-bit low precision. Also, when initializing the adapter weights in the PEFT technique, the adapter weights may be initialized so that all adapter layers have the same rank size, and thus, the rank size of the adapter layers may not be considered separately.

In an example, an electronic device and method of one or more embodiments may alleviate the accuracy degradation occurring in low-precision quantization-based PEFT by compensating for quantization errors by the ranks of the adapter weights used in the PEFT technique. For example, the electronic device and method of one or more embodiments may dynamically adjust the ranks of the adapter layers using rank-subspace analysis and optimize performance with fewer parameters, thereby addressing the accuracy degradation.

In an example, by effectively compensating for quantization errors by the ranks of the adapter weights, the electronic device and method of one or more embodiments may improve the accuracy of fine-tuning learning according to the quantization-based PEFT technique at 2-bit low precision, obtain higher fine-tuning accuracy results with fewer training parameters, and generate an LLM that is memory-efficient, excellent in performance, and optimized for a desired performance capability.

Here, the “rank” may refer to the dimension of a vector space represented by a matrix (e.g., a weight matrix). The rank may be defined as the maximum number of linearly independent vectors in a column or row of a matrix. The rank may play an important role in evaluating the representational power of the neural network model. For example, as the rank of the weight matrix is higher, the neural network may learn more complex patterns and relationships. When the rank of the weight matrix is high, the neural network may effectively represent more dimensions of data, which may help the neural network model better catch various features of input data and solve complex problems. A high rank may help a neural network model be better normalized for new data without overfitting to training data, thereby enabling the neural network model to predict more accurately in an actual environment. In addition, a low rank may reduce the computational efficiency of a neural network model, which may affect learning speed and prediction performance. For at least these reasons, the electronic device and method of one or more embodiments may properly adjust the ranks during the process of designing and training neural network models.

In fine-tuning 230, the base weights may remain the same, while the adapter weights may be adjusted or changed. Furthermore, the final weights may be determined by addition between high-precision adapter weights and low-precision quantized base weights obtained by quantizing the base weights.

Through low-precision fine-tuning 230 for the neural network model, the electronic device and method of one or more embodiments may maintain the relatively large base weights as they are and adjust or change only the relatively small adapter weights, thereby effectively reducing the amount of computation for fine-tuning 230, improving computation speed, and reducing memory overhead. Hereinafter, an example of fine-tuning 230 will be described in more detail with reference to FIG. 3.

FIG. 3 illustrates an example of adapter weights used in fine-tuning.

Referring to FIG. 3, adapter weights 320 according to an example may be weights to effectively reduce the computational and memory costs of fine-tuning a neural network model. The adapter weights 320 may be expressed as the product of two matrices (e.g., L₁ and L₂) that are smaller than the size of quantized base weights 310. For example, each of the matrices L₁ and L₂ may be represented by a lower rank than the quantized base weights 310.

The quantized base weights 310 may be a matrix where the values determined during the pre-training process described above are quantized, and may be frozen weights that remain constant, e.g., not adjusted or changed during the fine-tuning process.

In the fine-tuning process, the adapter weights 320 may be trainable weights that may be adjusted or changed. The quantized base weights 310 and the adapter weights 320 may be, for example, W̅_{q}∈ [symbol] ^{d×k}, L₂∈ [symbol] ^{d×r}, L₁ ∈ [symbol] ^{r×k}, but are not limited to the foregoing examples.

The initial values of the adapter weights 320 may be determined from the differences between base weights determined during the pre-training process and the quantized base weights 310 obtained by quantizing the base weights. For example, the initial values of the adapter weights 320 may be determined by approximating the differences between the base weights and the quantized base weights 310 to low ranks based on singular value decomposition (SVD), which may be represented by Equation 1 below, for example.

$$\overline{{W}_{q}} = Q ( {W}_{0} ) \qquad Equation 1$$

$${W}_{0} = \overline{{W}_{q}} + {{Error \approx \overline{{W}_{q}} + {{L}_{2}}_{↑}}_{⎵} {L}_{1}}_{SVD}$$

In Equation 1, W₀ may denote the pre-trained base weights, Q( ) may denote a quantization operation, and W̅_{q} may denote the quantized base weights 310.

When the initial values of the adapter weights 320 are determined based on errors occurring when the base weights are quantized and the adapter weights 320 are adjusted or changed during fine-tuning, fine-tuning may be performed to reduce the errors due to quantization by reflecting the errors due to quantization to a loss function.

When training with respect to the adapter weights 320 is completed through fine-tuning, data inference may be performed using a neural network model including the base weights and the adapter weights 320. The data inference may include, for example, pattern recognition (e.g., object recognition, face identification, etc.), sequence recognition (e.g., speech, gesture, and handwritten texture recognition, machine translation, machine interpretation, etc.), control (e.g., vehicle control, processor control, etc.), recommendation services, decision making, medical examination or diagnosis, financial applications, data mining, and the like. However, the examples of data inference are not limited thereto.

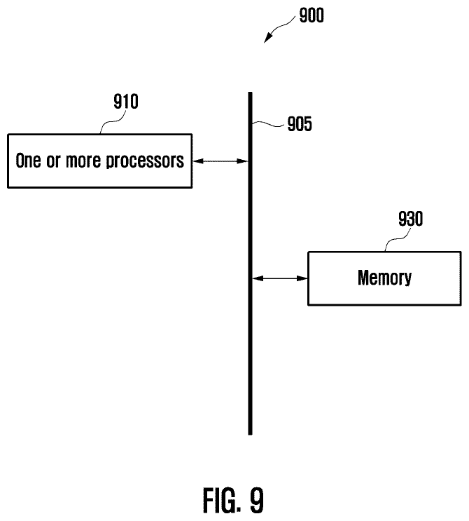

The weights utilized for data inference may be stored in a memory (e.g., a memory 930 of FIG. 9). For example, a result of addition between the quantized base weights and the adapter weights may be stored in the memory at low precision. Alternatively, the base weights and the adapter weights may be stored separately in the memory, and an addition operation between the base weights and the adapter weights may be performed when performing inference.

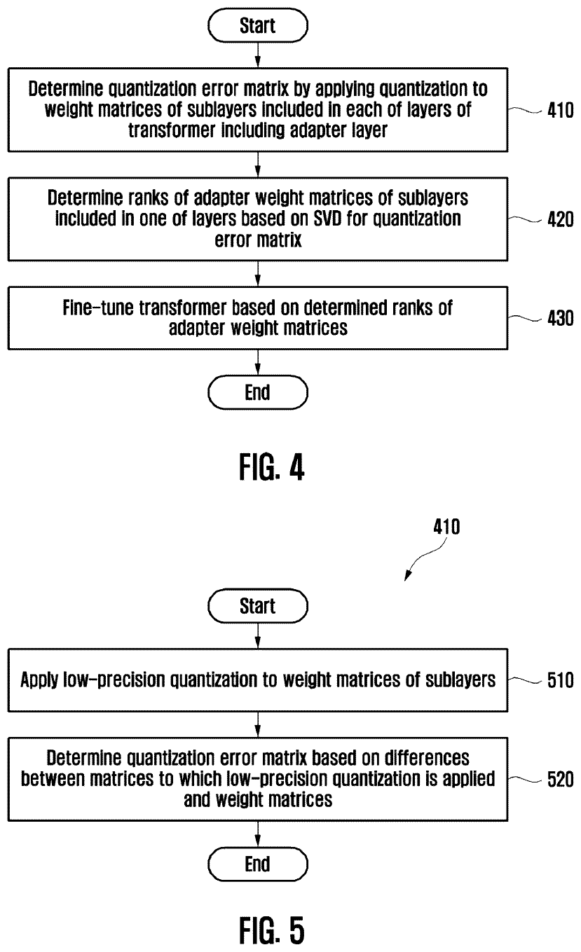

FIG. 4 illustrates an example of a method of fine-tuning a transformer. In the following examples of FIGS. 4-8, respective operations may be performed sequentially, but are not necessarily performed sequentially. For example, the order of the operations may be changed, one or more of the operations may be omitted, and at least two of the operations may be performed in parallel or simultaneously without departing from the spirit and scope of the example embodiments described herein.

Referring to FIG. 4, an electronic device according to an example may fine-tune a transformer through operations 410 to 430. The transformer may be, for example, the transformer 100 described above with reference to FIG. 1, but is not necessarily limited thereto.

In operation 410, the electronic device may determine a quantization error matrix by applying quantization to weight matrices of sublayers included in each of layers of a transformer including an adapter layer (e.g., the adapter layer 130 of FIG. 1). The weight matrices of the sublayers may include, for example, a query vector, a key vector, a value vector, an output projection vector, and a hyperparameter of at least one of one or more fully connected layers, but is not necessarily limited thereto.

Quantization may refer to a technique for reducing the precision of parameters of a neural network model to reduce memory and computational requirements. In a deep learning model, parameters may be stored as 32-bit floating-point numbers. However, when quantization is used, the parameters may be expressed at lower-bit precision, such as by 8-bit integers or 2-bit integers. The electronic device and method of one or more embodiments may reduce precision using lower bits, thereby reducing memory usage and increasing computational speed.

Quantization for weight matrices may be a technique for reducing memory requirements and increasing computational efficiency by compressing the parameters of a neural network model. As described in examples more specifically below, quantization aware training (QAT), one of the quantization techniques, may be conveniently used to compress pre-trained models but has a low inference accuracy in a low-bit environment.

Thus, in an example, low-rank adaptation (LoRA), which efficiently re-parameterizes weight matrices, may be used to fine-tune an LLM in various application programs. LoRA may perform fine-tuning with a considerably small number of trainable parameters by introducing adapter matrices A and B and freezing pre-trained weights W. The basic assumption of LoRA may be that an update applied to a pre-trained LLM during fine-tuning for downstream training exhibits a low-rank structure.

An example of a method of determining a quantization error matrix by the electronic device will be described in more detail with reference to FIG. 5 below.

In operation 420, the electronic device may determine ranks of adapter weight matrices of sublayers included in one of the layers based on SVD for the quantization error matrix determined in operation 410. SVD may correspond to a matrix decomposition technique for separating a high-dimensional matrix having a number of features into low-dimensional matrices. SVD may include an operation of returning singular values basically as column vectors.

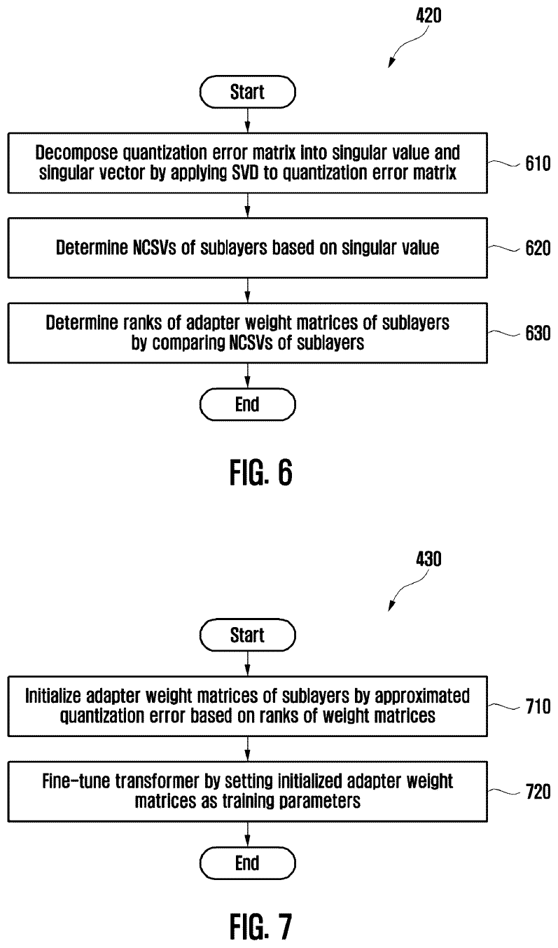

The electronic device may approximate the weight matrices of the neural network model to low-rank matrices, for example, by low-rank factorization such as SVD. The electronic device may decompose the weight matrices into low ranks, thereby reducing the number of parameters and computational complexity of the neural network model. Low-rank factorization may provide an option for parameter-efficient fine-tuning (PEFT) (e.g., parameter-efficient transfer learning for NLP), to find low-rank approximations that retain the most important information for a task performed by the neural network model. An example of a method of determining the ranks of adapter weight matrices by the electronic device will be described in more detail with reference to FIG. 6.

In operation 430, the electronic device may fine-tune the transformer based on the ranks of the adapter weight matrices determined in operation 420. The electronic device may fine-tune the transformer, for example, by the PEFT method. The PEFT method may selectively update or adjust only a portion of all the parameters (e.g., a portion of all the parameters of an adapter layer), rather than updating all the parameters when training a neural network model.

Updating all the parameters may be a full fine-tuning method, where all the parameters of a pre-trained model (PLM) are re-learned to update the weights. Full fine-tuning may optimize the general-purpose performance of an LLM to a predetermined task or domain, but it may be difficult to support in terms of resources as the size of a deep learning model increases.

Therefore, the electronic device and method of one or more embodiments may reduce the difficulty of learning by selectively adjusting or updating a portion of all the parameters of the neural network model by the PEFT method, and adjust the neural network model to be suitable for a predetermined function or task while maintaining the core structure of the neural network model. The PEFT method may maintain the performance of the neural network model similar to the typical methods, while learning much fewer training parameters than the full fine-tuning method.

In operation 430, the electronic device may initialize the adapter weight matrices of the sublayers. The electronic device may fine-tune the transformer by setting the initialized adapter weight matrices as training parameters. The transformer may be included in, for example, one of an encoder-only model and an LLM, but is not necessarily limited thereto. An example of a method of fine-tuning a transformer by the electronic device will be described in more detail with reference to FIG. 7 below.

When inference is performed using the fine-tuned transformer according to an example, the electronic device including the fine-tuned transformer may dequantize the quantized and stored weights W_{q} (e.g., the quantized base weights 310 W̅_{q} of FIG. 3) to the original precision, and output W_{q}X by performing a matrix product operation with an activation value X that is input.

In this case, since the adapter weights L₂ and L₁ (e.g., the adapter weights 320 L₂ and L₁ of FIG. 3), which are adapter components, are not quantized, the electronic device may output L₂L₁X by performing a matrix product operation like the input activation value X. The electronic device may perform inference using X (W_{q}+L₂L₁), which is the sum of L₂L₁X and the previous operation result W_{q}X, as weights.

FIG. 5 illustrates an example of determining a quantization error matrix. Referring to FIG. 5, an electronic device according to an example may determine a quantization error matrix through operations 510 and 520.

In operation 510, the electronic device may apply low-precision quantization to the weight matrices of the sublayers. Low-precision quantization may refer to a technique for converting weights and activation values of a neural network model from high-precision data expressions (e.g., 32-bit floating points) to low-precision data expressions (e.g., 2-bit integers). Low-precision quantization may reduce the size and memory usage (e.g., memory usage of the memory 930 of FIG. 9) of the neural network model and improve computational speed.

Low-precision quantization may be performed by, for example, a dynamic quantization technique for quantizing weights in advance and dynamically quantizing activation values during inference, a static quantization technique for reducing memory usage and increasing computational speed by quantizing a trained neural network model, and a quantization aware training (QAT) technique for minimizing a loss after quantization by simulating a quantization effect during a training process, but is not necessarily limited thereto. The static quantization technique may also be referred to as the “post-training quantization (PTQ) technique”.

Quantization for weight matrices may discretize a pre-trained weight matrix W∈ [symbol] ^{d}^{₁}^{×d}^{₂} into a limited number of bits, thereby reducing memory space and enabling optimized hardware utilization.

In an example, a quantized weight matrix W_{Q}=Q_{N}(H) may be defined using Min-Max-based uniform quantization as shown in Equation 2 below, for example.

$${W}_{Q} = {Q}_{N} ( W ) = s ⌊ \frac{W - z}{s} ⌉ + z . \qquad Equation 2$$

In Equation 2, └⋅┐ may denote a rounding function.

A scale factor

$$S = \frac{max ( W ) - min ( W )}{{2}^{N} - 1}$$

may be determined by the minimum or maximum value of each quantization group. N may denote the bit width, and the zero point may be z=min(W).

In operation 520, the electronic device may determine the quantization error matrix based on differences between the matrices to which the low-precision quantization is applied in operation 510 and the weight matrices.

In an example, the quantization error matrix may be determined based on an analysis result that 2-bit low-precision quantization errors exhibit high rank characteristics. Compared to 3-bit precision and 4-bit precision, which are relatively high, 2-bit low-precision quantization errors may represent very high quantization error size. Further, to achieve a result close to floating-point precision (e.g., FP 16-bit) accuracy in quantization-based fine-tuning, the size of the ranks of the adapter weights may be increased to ranks at the same level as the size of the original weight matrices of an LLM. From this analysis, it may be verified that 2-bit low-precision quantization errors exhibit high rank characteristics.

As discussed in more detail below, the electronic device may analyze the changes in adapter weights from the perspective of singular values and singular vectors that are results of SVD of the adapter weights, during the process of performing low-precision quantization-based fine-tuning.

As the singular values gradually increase at respective rank positions in the training process through a singular value analysis, the characteristic of a movement for compensating for quantization errors in a subspace of limited ranks may be verified. Furthermore, the singular value analysis result may indicate that vectors with small singular values play a key role in the fine-tuning process to correct quantization errors and hinder effective and parameter-efficient error compensation through LoRA. In addition, the characteristics of quantization errors in the subspace of ranks may depend on the positions in the neural network model, for example, the weights of a feedforward layer and an output projection layer and on the layer numbers.

In addition, through a singular vector analysis, it may be verified that ranks used during the process of compensating for quantization errors differ in size, for the types of sublayers of an LLM.

In an example, a method of setting ranks used to compensate for quantization errors in each sublayer differently may be used through such analysis. This method may be called “Rank-Adaptive (RA) LoRA”.

In an example, RA-LoRA of one or more embodiments may more efficiently use the number of training parameters and more accurately compensate for quantization errors during the quantization-based fine-tuning process, thereby improving the learning performance of the fine-tuning process. RA-LoRA may dynamically adjust the ranks of the adapters according to the subspace analysis of the ranks to effectively offset the quantization errors with fewer parameters during the fine-tuning process. An example of RA-LoRA will be described in more detail through Table 1 below.

FIG. 6 illustrates an example of determining ranks of adapter weight matrices. Referring to FIG. 6, an electronic device according to an example may determine the ranks of the adapter weight matrices through operations 610 to 630.

In operation 610, the electronic device may decompose the quantization error matrix into a singular value and a singular vector by applying SVD to the quantization error matrix determined in operation 520. The electronic device may determine the ranks of the adapter weight matrices of the sublayers based on the singular value decomposed in operation 610.

For example, in operation 620, the electronic device may determine normalized cumulative singular values (NCSVs) of the sublayers based on the singular value decomposed in operation 610. In an example, a metric called NCSV may be used to measure the intrinsic ranks of quantization errors, based on the insight that not all sublayers need high ranks to cover the subspace to mitigate the quantization errors. The electronic device may use the NCSVs as guiding indices to effectively assign ranks to the sublayers to address quantization errors in fine-tuning.

In operation 630, the electronic device may determine the ranks of the adapter weight matrices of the sublayers by comparing the NCSVs of the sublayers determined in operation 620. The electronic device may sort the NCSVs of the sublayers in descending order. The electronic device may determine the ranks of the adapter weight matrices of the sublayers based on indices of the sublayers sorted in descending order.

FIG. 7 illustrates an example of fine-tuning a transformer. Referring to FIG. 7, an electronic device according to an example may fine-tune a transformer through operations 710 and 720.

In operation 710, the electronic device may initialize the adapter weight matrices of the sublayers by an approximated quantization error based on the ranks of the weight matrices.

In operation 720, the electronic device may fine-tune the transformer by setting the adapter weight matrices initialized in operation 710 as training parameters.

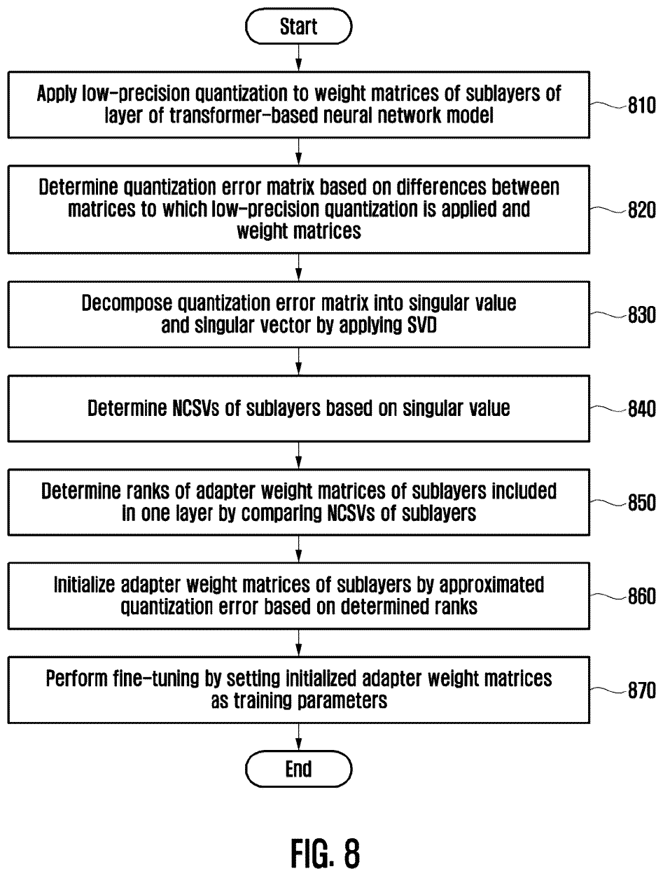

FIG. 8 illustrates an example of a method of fine-tuning a transformer. Referring to FIG. 8, an electronic device according to an example may perform fine-tuning of a transformer through operations 810 to 870.

In operation 810, the electronic device may apply low-precision quantization to weight matrices of sublayers of a layer of a transformer-based neural network model.

In operation 820, the electronic device may determine the quantization error matrix based on differences between the weight matrices to which the low-precision quantization is applied in operation 810 and the weight matrices.

In operation 830, the electronic device may decompose the quantization error matrix determined in operation 820 into a singular value and a singular vector by applying SVD.

In operation 840, the electronic device may determine NCSVs of the sublayers based on the singular value decomposed in operation 830.

In operation 850, the electronic device may determine ranks of adapter weight matrices of sublayers included in one layer of the transformer-based neural network model by comparing the NCSVs of the sublayers.

In operation 860, the electronic device may initialize the adapter weight matrices of the sublayers by an approximated quantization error based on the ranks determined in operation 850.

In operation 870, the electronic device may perform fine-tuning by setting the adapter weight matrices initialized in operation 860 as training parameters.

The above process may be represented as the RA-LoRA algorithm shown in Table 1 below.

The RA-LoRA algorithm may assign optimal ranks to the sublayers of each block of the transformer using the NCSVs σ̅ in SVD of the quantization error matrix.

The RA-LoRA algorithm may set a target average rank r and effectively determine rank allocation using an r-th index of a normalized value. The effective ranks of the sublayers may be adjusted based on the relative size of the singular value, and sublayers with higher values in the target rank may be assigned lower ranks.

TABLE 1
Algorithm 1 RA-LoRA Pseudo Algorithm

Input: weights W, target rank r, quantizer Q_{N} (·), Hyper-
parameters α, β, γ with α > β > γ
Output: adapted rank A for each sublayer

| | |
|---|---|
| 1: | # Denfine rank candidates based on target rank and hyper- |
| | parameters |
| 2: | { [symbol] ₀, [symbol] ₁, ..., [symbol] ₅, [symbol] ₆} ← {r/α, ..., r/β, ..., r/γ} |
| 3: | # Iterate over weights in the same block |
| 4: | for key in {q, k, v, o, fc₁, fc₂, fc₃} do |
| 5: | W ← W_{key} |
| 6: | W_{Q} ← Q_{N} (W) |
| 7: | # Obtain singular vector from the error |
| 8: | σ ← SVD(W − W_{Q}) |
| 9: | # Normailize simgular vector |
| 10: | $\overline{σ} ← {\overline{σ}}_{k} = {σ}_{k}^{2} / {‖ σ ‖}_{2}^{2}$ |
| 11: | # Calculate normalized cumulative singular value for |
| | target rank |
| 12: | ${c}_{key} ← {\sum }_{k = 1}^{r} {\overline{σ}}_{k}$ |
| 13: | end for |
| 14: | # Sort sublayers by normalized cumulative singular values |
| | in decending order |
| 15: | keys_sorted ← sort_indices_descending(c) |
| 16: | # Assign rank candidates based on sorted indices and |
| | inversely to their normalized values |
| 17: | for i in 0 to 7 do |
| 18: | R_{keys}_sorted[i] ← [symbol] ᵢ |
| 19: | end for |
| 20: | return [symbol] |

Here, W may denote weights. r may denote the target rank. Q_{N}(⋅) may be a quantizer. α, β, and γ may denote hyperparameters. R may denote adapted ranks for the sublayers.

The electronic device may define rank candidates based on the target rank and the hyperparameters. { [symbol] ₀, [symbol] ₁, . . . , [symbol] ₅, [symbol] ₆}←{r/α, . . . , r/β, . . . , r/γ} may denote rank candidates defined based on the target rank and the hyperparameters.

In the RA-LoRA algorithm described in Table 1, lines 4 to 13 may correspond to operations 830 to 850.

The electronic device may iterate the operations of lines 4 to 13 for the weights in the seven layers, such as {q, k, v, o, fc₁, fc₂, fc₃} q may denote a query vector, k may denote a key vector, and v may denote a value vector. O may denote an output projection vector. Also, fc₁, fc₂, and fc₃ may denote fully connected layers.

The electronic device may obtain a singular vector σ through SVD on the difference between the weight vector and a pre-trained quantized weight matrix W_{Q} as expressed by σ←SVD (W−W_{Q}).

The electronic device may normalize the singular vector σ as expressed by

$$\overline{σ} ← {\overline{σ}}_{k} = {σ}_{k}^{2} / {‖ σ ‖}_{2}^{2} .$$

The electronic device may determine an NCSV for the target rank r as expressed by

$${c}_{key} ← {\sum }_{k = 1}^{r} {\overline{σ}}_{k} .$$

The electronic device may pinpoint values at indices up to the target rank

$${\sum }_{k = 1}^{r} {\overline{σ}}_{k}$$

by determining NCSVs σ̅ in the sublayers of the transformer.

The electronic device may sort the sublayers in descending order by the NCSVs as expressed by keys_sorted←sort_indices_descending(c).

The electronic device may assign rank candidates, as expressed by R_{keys_sorted[i]}← [symbol] ᵢ, for the indices of the seven sublayers sorted in descending order, such that the assigned rank candidates may be inversely proportional to the NCSVs.

The RA-LoRA algorithm of one or more embodiments may adjust the ranks of the adapter layers through rank-subspace analysis, thereby mitigating quantization errors and improving performance in low-bit scenarios.

Further in operation 870, in response to the fine-tuning being performed, the electronic device may perform data inference using the fine-tuned transformer. The data inference may include, for example, pattern recognition (e.g., object recognition, face identification, etc.), sequence recognition (e.g., speech, gesture, and handwritten texture recognition, machine translation, machine interpretation, etc.), control (e.g., vehicle control, processor control, etc.), recommendation services, decision making, medical examination or diagnosis, financial applications, data mining, and the like. For example, for the performing of the data inference, an encoder of the transformer may receive an input sequence and a decoder of the transformer may output an output sequence.

FIG. 9 illustrates an example of an electronic device. Referring to FIG. 9, an electronic device 900 according to an example includes one or more processors 910 and a memory 930 (e.g., one or more memories). The one or more processors 910 and the memory 930 may communicate with each other via a bus 905.

The electronic device 900 may include, for example, various computing devices such as a mobile phone, a smartphone, a tablet computer, an electronic-book device, a laptop, a personal computer (PC), a desktop computer, a workstation or a server, various wearable devices such as a smart watch, smart eyeglasses, a head-mounted display (HMD), or smart clothes, various home appliances such as a smart speaker, a smart television (TV), or a smart refrigerator, and other devices such as a smart vehicle, a smart kiosk, an Internet of things (IoT) device, a walking assist device (WAD), a drone, or a robot.

The one or more processors 910 may be devices that execute instructions or programs or control the electronic device 900 and may include, for example, graphics processing units (GPUs) or tensor processing units (TPUs). In addition, in some examples, the one or more processors 910 may include central processing units (CPUs).

The one or more processors 910 may perform the operations described above as at least some of the instructions stored in the memory 930 are executed by the one or more processors 910.

The memory 930 stores instructions executable by the one or more processors 910. The memory 930 may be a volatile memory or a non-volatile memory. For example, the memory 930 may be or include a non-transitory computer-readable storage medium storing instructions that, when executed by the one or more processors 910, configure the one or more processors 910 to perform any one, any combination, or all of the operations and/or methods disclosed herein with reference to FIGS. 1-8.

The electronic device 900 controls the one or more processors 910 to determine a quantization error matrix by applying quantization to weight matrices of sublayers included in each of layers of a transformer including an adapter layer, determine ranks of adapter weight matrices of sublayers included in one of the layers based on SVD for the quantization error matrix, and fine-tune the transformer based on the ranks of the adapter weight matrices.

The electronic device 900 may apply quantization to the weight matrices of the sublayers, and determine the quantization error matrix through the differences between the existing matrices and the quantization matrices. The electronic device 900 may determine ranks of the weight matrices using values generated by applying SVD to the determined error matrix. The electronic device 900 may initialize the weight matrices based on the determined ranks and utilize the initialized weight matrices for fine-tuning.

The electronic device 900 may improve the accuracy of quantization-based PEFT learning at 2-bit low precision through the process described above, and achieve higher fine-tuning accuracy with fewer learning parameters. Thus, the electronic device 900 may generate an LLM that is memory-efficient, excellent in performance, and optimized for performance capability.

The transformers, electronic devices, one or more processors, memories, buses, transformer 100, electronic device 900, one or more processors 910, memory 930, and bus 905 described herein, including descriptions with respect to respect to FIGS. 1-9, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-9 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method comprising:
determining a quantization error matrix by applying quantization to weight matrices of sublayers included in each of layers of a transformer comprising an adapter layer;
determining ranks of adapter weight matrices of sublayers included in one of the layers based on singular value decomposition (SVD) for the quantization error matrix; and
fine-tuning the transformer based on the ranks of the adapter weight matrices.

2. The method of claim 1, wherein the determining of the quantization error matrix comprises:
applying low-precision quantization to the weight matrices of the sublayers; and
determining the quantization error matrix based on differences between the matrices to which the low-precision quantization is applied and the weight matrices.

3. The method of claim 1, wherein the determining of the ranks of the adapter weight matrices comprises:
decomposing the quantization error matrix into a singular value and a singular vector by applying SVD to the quantization error matrix; and
determining the ranks of the adapter weight matrices of the sublayers based on the singular value.

4. The method of claim 3, wherein the determining of the ranks of the adapter weight matrices of the sublayers comprises:
determining normalized cumulative singular values (NCSVs) of the sublayers based on the singular value; and
determining the ranks of the adapter weight matrices of the sublayers by comparing the NCSVs of the sublayers.

5. The method of claim 4, wherein the determining of the ranks of the adapter weight matrices of the sublayers comprises:
sorting the NCSVs of the sublayers in descending order; and
determining the ranks of the adapter weight matrices of the sublayers based on indices of the sublayers sorted in descending order.

6. The method of claim 1, wherein the fine-tuning of the transformer comprises:
initializing the adapter weight matrices of the sublayers; and
fine-tuning the transformer by setting the initialized adapter weight matrices as training parameters.

7. The method of claim 6, wherein the initializing of the adapter weight matrices of the sublayers comprises initializing the adapter weight matrices of the sublayers by an approximated quantization error based on the ranks of the weight matrices.

8. The method of claim 1, wherein the sublayers comprise a query vector, a key vector, a value vector, an output projection vector, and a hyperparameter of one or more fully connected layers.

9. The method of claim 1, wherein the transformer is included in one of an encoder-only model and a large language model (LLM).

10. A non-transitory computer-readable storage medium storing instructions that, when executed by one or more processors, configure the one or more processors to perform the method of claim 1.

11. A processor-implemented method comprising:
applying low-precision quantization to weight matrices of sublayers of a layer of a transformer-based neural network model;
determining a quantization error matrix based on differences between the matrices to which the low-precision quantization is applied and the weight matrices;
decomposing the quantization error matrix into a singular value and a singular vector by applying singular value decomposition (SVD);
determining normalized cumulative singular values (NCSVs) of the sublayers based on the singular value;
determining ranks of adapter weight matrices of sublayers included in one layer by comparing the NCSVs of the sublayers;
initializing the adapter weight matrices of the sublayers by an approximated quantization error based on the determined ranks; and
performing fine-tuning by setting the initialized adapter weight matrices as training parameters.

12. An electronic device comprising:
one or more processors configured to:
determine a quantization error matrix by applying quantization to weight matrices of sublayers included in each of layers of a transformer comprising an adapter layer;
determine ranks of adapter weight matrices of sublayers included in one of the layers based on singular value decomposition (SVD) for the quantization error matrix; and
fine-tune the transformer based on the determined ranks of the adapter weight matrices.

13. The electronic device of claim 12, wherein, for the determining of the quantization error matrix, the one or more processors are configured to:
apply low-precision quantization to the weight matrices of the sublayers; and
determine the quantization error matrix based on differences between the matrices to which the low-precision quantization is applied and the weight matrices.

14. The electronic device of claim 12, wherein, for the determining of the ranks of the adapter weight matrices, the one or more processors are configured to:
decompose the quantization error matrix into a singular value and a singular vector by applying SVD to the quantization error matrix; and
determine the ranks of the adapter weight matrices of the sublayers based on the singular value.

15. The electronic device of claim 14, wherein, for the determining of the ranks of the adapter weight matrices of the sublayers, the one or more processors are configured to:
determine normalized cumulative singular values (NCSVs) of the sublayers based on the singular value; and
determine the ranks of the adapter weight matrices of the sublayers by comparing the NCSVs of the sublayers.

16. The electronic device of claim 15, wherein, for the determining of the ranks of the adapter weight matrices of the sublayers, the one or more processors are configured to:
sort the NCSVs of the sublayers in descending order; and
determine the ranks of the adapter weight matrices of the sublayers based on indices of the sublayers sorted in descending order.

17. The electronic device of claim 12, wherein, for the fine-tuning of the transformer, the one or more processors are configured to:
initialize the adapter weight matrices of the sublayers; and
fine-tune the transformer by setting the initialized adapter weight matrices as training parameters.

18. The electronic device of claim 12, wherein, for the initializing of the adapter weight matrices of the sublayers, the one or more processors are configured to initialize the adapter weight matrices of the sublayers by an approximated quantization error based on the determined ranks of the weight matrices.

19. The electronic device of claim 12, wherein the sublayers comprise a query vector, a key vector, a value vector, an output projection vector, and a hyperparameter of one or more fully connected layers.

20. The electronic device of claim 12, wherein the transformer is included in one of an encoder-only model and a large language model (LLM).
